(19) United States
(12) Patent Application Publication
(10) Pub. No.: US 2009/0204667 A1
(43) Pub. Date: Aug. 13, 2009

(54) User-Initiated Computer Support Using Out-Of-Band Network

(76) Inventors: Osvaldo Diaz, San Mateo, CA (US); Mamoun Abu-Samaha, San Jose, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 12/341,001

(22) Filed: Dec. 22, 2008

Related U.S. Application Data
(60) Provisional application No. 61/028,298, filed on Feb. 13, 2008.

(51) Int. Cl. G06F 15/16

(52) U.S. Cl. 709/203

(57) ABSTRACT

A user detects a computer failure. The user communicates the fact of the fault to a support server. The support server requests a central management server to access diagnostic data on the computer. The central management server accesses the diagnostic data via a lights-out module of the computer and forwards the diagnostic data to the support server.

This application claims the benefit of copending provisional application 61/028,298, filed Feb. 13, 2008.

### BACKGROUND

Centralized management permits information technology (IT) staff to manage a large number of computers remotely. So that computers can be managed when off or in the event of an operating system (OS) or a network failure, managed computers can be provided with “lights-out modules” that are connected to a central management server over an out-of-band network (a network not used by the operating system used to communicate). Wireless out-of-band networks have been developed so that IT staff can manage suitably equipped laptop computers and other mobile computers.

Small and medium-sized businesses (SMBs) are often too small too justify an internal IT staff. Accordingly, SMBs sometimes contract with a computer-support vendor to handle computer failures. In some cases, a computer-support customer may be required to bring a computer into a support facility for diagnosis and repair, while, in other cases, a support technician may come to the SMBs facilities to address computer problems.

### BRIEF DESCRIPTION OF THE DRAWINGS

The features and advantages of the invention as well as additional features and advantages thereof will be more clearly understood hereinafter as a result of a detailed description of a preferred embodiment of the invention when taken in conjunction with the following drawings in which:

FIG. 1 is a schematic diagram of a computer system in accordance with an embodiment of the invention.

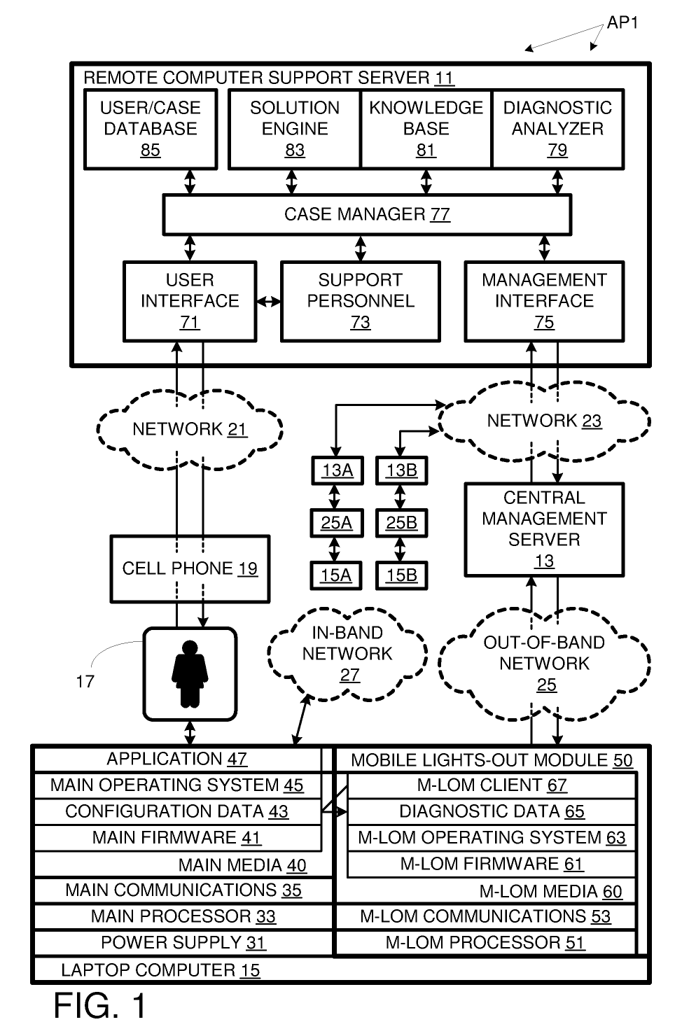

FIG. 2 is a flow chart of a method in accordance with an embodiment of the invention.

### DETAILED DESCRIPTION

The present invention provides an automated support server that communicates with a central management server, which in turn provides out-of-band access to a target computer. In a sense, the centralized management server is being used to provide for decentralized self help, that is support is user driven rather than managed by an IT staff. Thus, for example, roaming SMB personnel can address failures of laptops and other mobile computers without requiring help from contracted or internal IT staff.

In accordance with an embodiment of the invention, a computer-support system API includes a remote computer-support server 11, a remote central management server 13, a laptop computer 15, and a user 17 of laptop computer 17 and a cell phone 19. User 17 communicates with support server 11 via a cellular network 21. Support server 11 communicates with central management server 15 via a network 23 such as the Internet. Central management server 15 communicates out-of-band with laptop 15 over a cellular network 25. As is explained in greater detail further below, the invention provides embodiments in which a variety of network technologies are used and in which computers other than laptops are serviced. Support server 11 can manage multiple computers, e.g., 15A and 15B, for different corporate SMB customers using different respective central management servers 13A and 13B and out-of-band networks 15A and 15B.

Laptop 13 includes a power supply 31, a main processor 33, main communications devices 35, and main media 40. Encoded on main media 37 are data and instructions, including BIOS firmware 41, configuration and error data 43, a main operating system 45, and an application 47. In addition, laptop 15 includes a mobile lights-out module (M-LOM) 50, which itself includes a M-LOM processor 51, M-LOM communications devices 53, and M-LOM media 60. M-LOM media 60 can store M-LOM firmware 61, M-LOM operating system 63, M-LOM diagnostic data 65, and M-LOM client 67. M-LOM client 67 is responsible for accessing configuration and error data 43 to generate diagnostic data 65.

M-LOM 50 is a “computer within a computer” that shares a common power supply. In an alternative embodiment, a separate battery is provided for the lights-out module so that if the main battery fails, the M-LOM can still be accessed. In that case, the main and M-LOM batteries can be charged using the same AC adapter. In the illustrated embodiment, an AC adapter can serve as a backup power supply in case the battery fails.

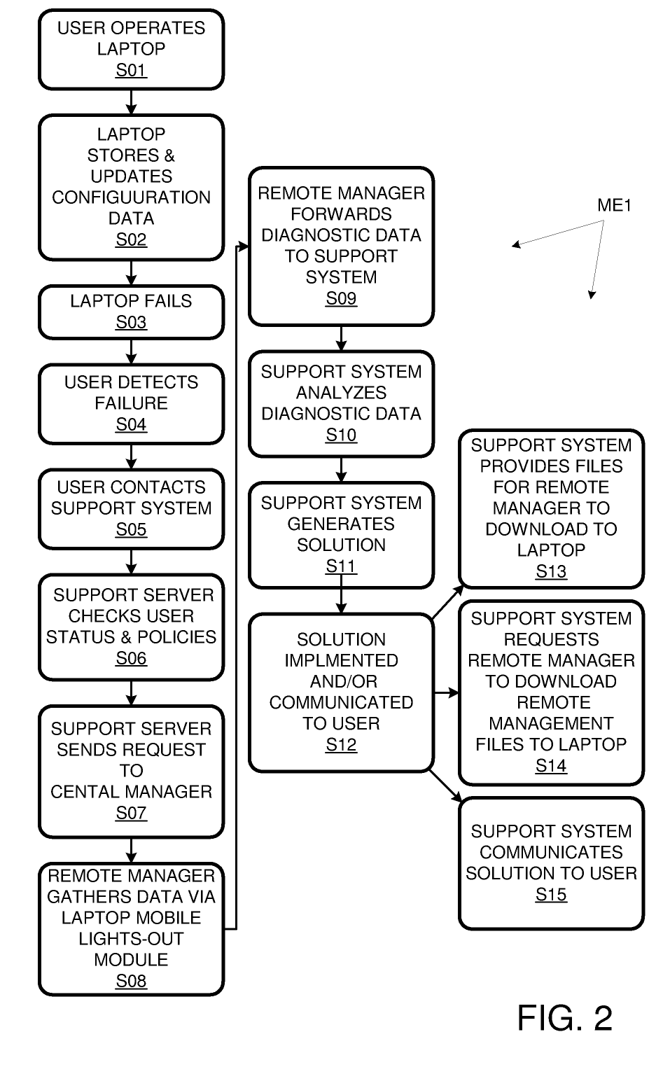

In the event of a battery or other failure, user 17 can contact remote computer support server 11 for service. Support server 11 includes a user interface 71, support personnel 73, a management interface 75, a case manager 77, a diagnostic analyzer 79, a knowledge base 81, a solution engine 83, and a user/case database 85. The functions of these components are described in the context of a method ME1, flow-charted in FIG. 2, in accordance with an embodiment of the invention.

At step S01, user 17 operates laptop 15. For example, user 17 may be interacting with application 47 to accomplish some task, e.g., word processing, accounting, or calendaring. At this point, application 47 and main operating system 45, both of which are constituted by computer-executable instructions, are being executed by main processor 33. Keyboard, track-pad, and touch-screen interactions by user 17 are managed by main communication devices, as are any network or Internet activity. The current configuration of laptop 15, including the current hardware and installed software is described in non-volatile memory of media 40. Lights-out module 50 is inactive during normal operation to save battery power.

At step S02, configuration data 43 is stored and updated. The current hardware and software configuration of laptop 15 is stored in non-volatile memory. During step S01, the configuration of laptop 15 can change in a variety of ways. In some cases, an internal hardware component can be changed. More commonly, a peripheral can be attached, inserted, or removed. A user can manually install software from local media or software can be installed or updated manually or automatically over the Internet or other network. As such changes are made, corresponding configuration data 43 is updated at step S02.

At step S03, laptop 15 fails. The failure can be “complete”, e.g., operating system 45 and application 47 cannot function, or “partial”, e.g., a performance impairment. At step S04, user 17 detects the failure. This detection can involve observing that laptop 15 fails to boot, suffers the “blue screen of death”, or seems “sluggish”.

At step S05, user 17 contacts remote computer support server 11 over network 21. In general, this involves communicating an identity of user 17 to support 11, e.g., a user name and password or an account number. In addition or instead, laptop 15 can be identified.

In the illustrated embodiment, network 21 is a cellular network supporting voice communications, texting, and World-Wide-Web access; user interface 71 includes a web server, an interactive voice and touch-tone driven menu, and texting (SMS) interaction. User 17 can use a cell phone 19 to access support server 11, even if laptop 15 has failed completely. Web access to support server 11 provides for the richest interaction, but not all cell phones support this. Also, some users may prefer access to support using voice or texting. Alternatively user 17 can use a landline or another computer to access support server 11. Other embodiments support other modes of communication, other types of networks, and other network protocols.

At step S06, support server 11 checks user status and policies. Case manager 77 checks the user and/or computer identity information obtained in step S05 against user/case database 85. This can involve determining whether or not user 17 or laptop 15 is associated with an account. For example, user 17 may have an individual account or laptop 15 may be associated with a corporate account.

If eligibility is confirmed, case manager 77 can further access user/case database to determine a level of service to which user 17 is entitled and to determine any account policies that might restrict the time, manner, or content involved in accessing laptop 15. Case manager 77 also uses database 85 to track the status the present support case (and other support cases). To this end, case manager 77 can assign a case identifier to the case initiated by user 17. In addition, case manager 77 can determine the identity of central management server 13 to be used in accessing laptop 15 (in case different customers' computers are accessed by different central management servers).

At step S07, assuming user 17 and laptop 15 are eligible for support, support server 11 sends a request over network 23 for diagnostic information to central management server 13. The request specifies any requirements or restrictions imposed by policies represented in database 85. Network 23 can be the Internet over which support server 17 and central management server 13 can communicate using a secure Internet protocol.

At step S08, central management server 13 gathers diagnostic data via the mobile lights-out module 50 of laptop 15. This can involve central management server 13 sending a “wake-up” command using an OMA-DM (Open Mobile Alliance-Device Management) protocol over out-of-band network 25 to lights-out-module 50. In the illustrated embodiment, network 25 is a cellular network and M-LOM communications devices 53 include a cellular transceiver. Also, in the illustrated embodiment, this cellular transceiver also serves as one of main communications devices 35 to provide for cellular networking during normal operation of laptop 15. In an alternative embodiment, a mobile lights-out module has a dedicated cellular device. In another alternative embodiment, an alternative wireless networking technology, e.g., WiFi, is used instead of cellular technology.

Wakening M-LOM 50 involves booting M-LOM operating system 63 and launching M-LOM client 67. Once M-LOM 50 is awake, client 67 acknowledges the wake-up command from central management server 13. Having received the acknowledgement, central management server 13 commands M-LOM client 67 to gather diagnostic data in accordance with the support policies represented in database 85. Data gathering can involve accessing main media 40 for configuration and other information not already represented in M-LOM media 60. This additional information can include error messages, for example. The additional data can be combined with previously gathered diagnostic data 65 for transmission to central management server 13 over network 25.

At step S09, central management server 13 forwards the gathered diagnostic data to management interface 75 and thus support server 11 over network 23. Note that, if at step S08, central management server 13 is unable to awaken LOM 50, this fact becomes the diagnostic data returned to support server 11. Case manager 77 updates the status of the current case in database 85.

At step S10, support server 11 analyzes the diagnostic data. Case manager 77 provides the diagnostic data to diagnostic analyzer 79. Diagnostic analyzer 79 analyzes the diagnostic data in the light of expertise provided by knowledge base 81 to determine one or more likely causes of the failure that is the subject of the current support case.

At step S11, solution engine 83 of support server 11 generates a solution. In the process, solution engine 83 can access knowledge base 81. For example, knowledge base 81 can include documents that present instruction for addressing a cause of a computer failure. If a solution cannot be found, support personnel 73 can intervene to provide a solution, communicating with user 17 as necessary.

At step S12 the solution is implemented and/or communicated to user 17. In some cases, the solution generated at step S11 can be automatically implemented. For example, at step S13, support server 11 can provide files, e.g., a firmware update, for central management server 13 to download to module 50. For another example, at step S14, support server 11 can request that central management server 13 download a file that server 13 has access to (but support server 11 does not).

In other cases, user action may be required. For example, at step S15, support server 11 communicates solution instructions to user 17 in the form of voice commands, text messages, or web pages. This communication can be to a user's cell phone, e.g., using network 21. In some cases, lights-out module 50 can activate a shell for user 17 to interface for receiving instructions. Also, lights-out module 50 may be able to resuscitate laptop 15 to the point where further instructions can be received over an in-band network 27.

Herein, a “server” is a computer or network of computers that provides services to other computers. A “lights-out module” is a component of a computer that provides network access to the computer even when the main operating system for the computer is not running. “Remote” describes a relationship between a computer and a server in which the server does not include the computer and the server must communicate with the computer over a network. Herein, related art is described to facilitate understanding of the invention. Related art labeled “prior art”, if any, is admitted prior art; related art not labeled “prior art” is not admitted prior art.

Although, the computer being serviced in the illustrated embodiment is a laptop, the invention can also be applied to support other types of mobile computers, e.g., netbooks and ultra-mobile personal computers, as well as non-mobile computers such as desktop computers.

The foregoing description, for purposes of explanation, has been described with reference to specific embodiments. However, the illustrative discussions are not intended to be exhaustive or to limit the invention to the precise forms disclosed. Many modifications and variations are possible in view of the disclosed teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A method comprising:
a user detecting a failure of a computer;
said user initiating support by communicating over a network to a support server the fact of said fault;
said support server requesting over a network a remote management system to gather diagnostic data from a lights-out module of said computer; and
said remote management system gathering said diagnostic data and forwarding it to said support server.

2. A method as recited in claim 1 further comprising:
said support server analyzing said diagnostic data to provide an analysis;
said support server generating a solution as a function of said analysis; and
said support server providing said solution to said user.

3. A method as recited in claim 1 wherein said lights-out module communicates with said remote management system over a wireless network.

4. A method as recited in claim 3 wherein said lights-out module communicates with said remote management system over a cellular network.

5. A method as recited in claim 4 wherein said user communicates with said support server using a cellular network and said support server communicates with said remote management system over the Internet.

6. A computer-support system comprising:
a user interface for receiving a use-initiated computer support request over a network from a user for a failed mobile computer;
a management interface for transmitting a request for a central management server to gather diagnostic data from said mobile computer via a lights-out module of said mobile computer and for receiving said diagnostic data from said remote management server;
a data analyzer for providing an analysis of said diagnostic data; and
a solution engine for providing a solution as a function of said analysis.

7. A computer-support server as recited in claim 6 further comprising said central management server, said remote management server communicating with said mobile computer over a wireless network.

8. A computer-support system as recited in claim 7 further comprising said lights-out module, said lights-out module responding to communications from said central management server even when an operating system on said mobile computer is inactive.

9. A computer-support system as recited in claim 6 wherein said user interface communicates said solution to said user.

10. A computer-support system as recited in claim 6 wherein said solution involves said central management server downloading instructions to said lights-out module.
